(19) United States
(12) Patent Application Publication
(10) Pub. No.: US 2017/0242822 A1
(43) Pub. Date: Aug. 24, 2017

(54) DRAM APPLIANCE FOR DATA PERSISTENCE

(71) Applicant: SAMSUNG ELECTRONICS CO., LTD., Suwon-si (KR)

(72) Inventors: Krishna T. MALLADI, San Jose, CA (US); Hongzhong ZHENG, Sunnyvale, CA (US)

(21) Appl. No.: 15/136,775

(22) Filed: Apr. 22, 2016

Related U.S. Application Data
(60) Provisional application No. 62/297,014, filed on Feb. 18, 2016.

(51) Int. Cl. G06F 15/173; H04L 29/08; G06F 1/30; G06F 3/06

(52) U.S. Cl. CPC G06F 15/17331; G06F 3/0619; G06F 3/065; G06F 3/0685; G06F 3/067; H04L 67/1097; H04L 67/1095; G06F 1/30

(57) ABSTRACT

A memory device includes: a plurality of volatile memories for storing data; a non-volatile memory buffer configured to store data associated with workloads received from a host computer; and a memory controller configured to store the data to both the plurality of volatile memories and the non-volatile memory buffer and replicate the data to a remote node. The non-volatile memory buffer is configured to store the data in a table including an acknowledgement bit that is set by the remote node.

### CROSS-REFERENCE TO RELATED APPLICATION(S)

This application claims the benefits of and priority to U.S. Provisional Patent Application Ser. No. 62/297,014 filed Feb. 18, 2016, the disclosure of which is incorporated herein by reference in its entirety.

### TECHNICAL FIELD

The present disclosure relates generally to memory systems for computers and, more particularly, to a system and method for providing a DRAM appliance for data persistence.

### BACKGROUND

Computer systems targeted for data intensive applications such as databases, virtual desktop infrastructures, and data analytics are storage-bound and sustain large data transaction rates. The workloads of these systems need to be durable, so data is often committed to non-volatile data storage devices (e.g., solid-state drive (SSD) devices). For achieving a higher level of data persistence, these computer systems may replicate data on different nodes in a storage device pool. Data replicated on multiple nodes can guarantee faster availability of data to a data-requesting party and a faster recovery of a node from a power failure.

However, commitment of data to a non-volatile data storage device may throttle the data-access performance because the access speed to the non-volatile data storage device is orders of magnitude slower than that of a volatile memory (e.g., dynamic random access memory (DRAM)). To address the performance issue, some systems use in-memory data sets to reduce data latency and duplicate data to recover from a power failure. However, in-memory data sets are not typically durable and reliable. Data replication over a network has inherent latency and underutilizes the high speed of volatile memories.

In addition to DRAMs, other systems use non-volatile random access memories (NVRAM) that are battery-powered or capacitor-backed to perform fast data commitment while achieving durable data storage. However, these systems may need to run applications with large datasets, and the cost for building such systems can be high due to the cost for a larger battery or capacitor to power the NVRAM during a power outage. To eliminate such a tradeoff, new types of memories such as a phase-change RAM (PCM), a resistive RAM (ReRAM), and a magnetic random access memory (MRAM) have been introduced to deliver fast data commitment with non-volatility at a speed and performance comparable to that of DRAMs. However, these systems face challenges with a write path and endurance. Further, the implementation of new types of memories may take massive fabrication investment to replace the mainstream memory technologies such as DRAM and flash memory.

### SUMMARY

According to one embodiment, a memory device includes: a plurality of volatile memories for storing data; a non-volatile memory buffer configured to store data associated with workloads received from a host computer; and a memory controller configured to store the data to both the plurality of volatile memories and the non-volatile memory buffer and replicate the data to a remote node. The non-volatile memory buffer is configured to store the data in a table including an acknowledgement bit that is set by the remote node.

According to another embodiment, a memory system includes: a host computer; a plurality of memory devices coupled to each other over a network. Each of the plurality of memory devices includes: a plurality of volatile memories for storing data; a non-volatile memory buffer configured to store data associated with workloads received from the host computer; and a memory controller configured to store the data to both the plurality of volatile memories and the non-volatile memory buffer and replicate the data to a remote node. The non-volatile memory buffer is configured to store the data in a table including an acknowledgement bit that is set by the remote node.

According to yet another embodiment, a method for replicating data includes: receiving a data write request including data and a logical block address (LBA) from a host computer; writing the data to one of a plurality of volatile memories of a memory device based on the LBA; creating a data entry for the data write request in a non-volatile memory buffer of the memory device. The data entry includes the LBA, a valid bit, an acknowledgement bit, and the data. The method further includes: setting the valid bit of the data entry; replicating the data to a remote node; receiving an acknowledgement that indicates a successful data replication to the remote node; updating the acknowledgement bit of the data entry based on the acknowledgement; and updating the valid bit of the data entry.

The above and other preferred features, including various novel details of implementation and combination of events, will now be more particularly described with reference to the accompanying figures and pointed out in the claims. It will be understood that the particular systems and methods described herein are shown by way of illustration only and not as limitations. As will be understood by those skilled in the art, the principles and features described herein may be employed in various and numerous embodiments without departing from the scope of the present disclosure.

### BRIEF DESCRIPTION OF THE DRAWINGS

The accompanying drawings, which are included as part of the present specification, illustrate the presently preferred embodiment and together with the general description given above and the detailed description of the preferred embodiment given below serve to explain and teach the principles described herein.

FIG. 1 illustrates an example memory system, according to one embodiment;

FIG. 2 shows an example data structure of a RAM buffer, according to one embodiment;

FIG. 3 shows an example data flow for a write request, according to one embodiment;

FIG. 4 shows an example data flow for a data read request, according to one embodiment; and

FIG. 5 shows an example data flow for data recovery, according to one embodiment.

The figures are not necessarily drawn to scale and elements of similar structures or functions are generally represented by like reference numerals for illustrative purposes throughout the figures. The figures are only intended to facilitate the description of the various embodiments described herein. The figures do not describe every aspect of the teachings disclosed herein and do not limit the scope of the claims.

### DETAILED DESCRIPTION

Each of the features and teachings disclosed herein can be utilized separately or in conjunction with other features and teachings to provide a system and method for providing a DRAM appliance for data persistence. Representative examples utilizing many of these additional features and teachings, both separately and in combination, are described in further detail with reference to the attached figures. This detailed description is merely intended to teach a person of skill in the art further details for practicing aspects of the present teachings and is not intended to limit the scope of the claims. Therefore, combinations of features disclosed in the detailed description may not be necessary to practice the teachings in the broadest sense, and are instead taught merely to describe particularly representative examples of the present teachings.

In the description below, for purposes of explanation only, specific nomenclature is set forth to provide a thorough understanding of the present disclosure. However, it will be apparent to one skilled in the art that these specific details are not required to practice the teachings of the present disclosure.

Some portions of the detailed descriptions herein are presented in terms of algorithms and symbolic representations of operations on data bits within a computer memory. These algorithmic descriptions and representations are used by those skilled in the data processing arts to effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms presented herein are not inherently related to any particular computer or other apparatus. Various general-purpose systems, computer servers, or personal computers may be used with programs in accordance with the teachings herein, or it may prove convenient to construct a more specialized apparatus to perform the required method steps. The required structure for a variety of these systems will appear from the description below. It will be appreciated that a variety of programming languages may be used to implement the teachings of the disclosure as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of an original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

The present disclosure describes a memory device that includes a non-volatile memory buffer that is battery-powered (or capacitor-backed). The non-volatile memory buffer is herein also referred to as a RAM buffer. The memory device can be a node in a data storage system that includes a plurality of memory devices (nodes). The plurality of nodes may be coupled to each other over a network to store replicated data. The RAM buffer can hold data for a certain duration to complete data replication to a node. The present memory device has a low-cost system architecture and can run a data intensive application that requires a DRAM-like performance as well as reliable data transactions that satisfy atomicity, consistency, isolation and durability (ACID).

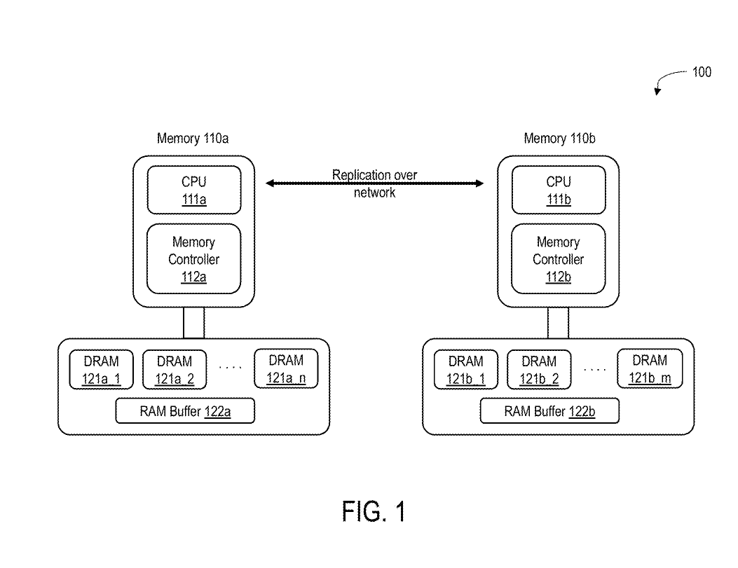

FIG. 1 illustrates an example memory system, according to one embodiment. The memory system 100 includes a plurality of memory devices 110a and 110b. It is understood that any number of memory devices 110 can be included in the present memory system without deviating from the scope of the present disclosure. Each of the memory device 110 can include a central processing unit (CPU) 111 and a memory controller 112 that is configured to control one or more regular DRAM modules (e.g., 121a_1-121a_n, 121b_1-121b_m) and a RAM buffer 122. Each of the memory devices 110a and 110b can be a hybrid dual in-line memory (DIMM) module that is configured to be inserted into a DIMM socket of a host computer system (not shown). The memory devices 110a and 110b can be transparent to the host computer system, or the host computer system can recognize the memory devices 110a and 110b as a hybrid DIMM module including a RAM buffer 122.

According to some embodiments, the architecture and constituent elements of the memory devices 110a and 110b can be identical or different. For example, the RAM buffer 122a of the memory device 110a can be capacitor-backed while the RAM buffer 122b of the memory device 110b can be battery-powered. It is noted that the examples herein directed to one of the memory devices 110a and 110b can be generally interchanged without deviating from the scope of the present disclosure unless explicitly stated otherwise.

The memory devices 110a and 110b are connected to each other over a network and can replicate data with each other. In one embodiment, a host computer (not shown) can run an application that commits data to the memory device 110a.

The RAM buffers 122a and 122b can be backed-up by a capacitor, a battery, or any other stored power source (not shown). In some embodiments, the RAM buffers 122a and 122b may be substituted with a non-volatile memory that does not require a capacitor or a battery for data retention. Examples of such non-volatile memory include, but are not limited to, a phase-change RAM (PCM), a resistive RAM (ReRAM), and a magnetic random access memory (MRAM).

According to one embodiment, the memory system 100 can be used in an enterprise or a datacenters. The data replicated in the memory system 100 can be used to recover the memory system 110 from a failure (e.g., power outage or accidental deletion of data). Generally, data replication to two or more memory devices (or modules) provides a stronger data persistence than data replication to a single memory device (or module). However, data access to or data recovery from a replicated memory device entails latency due to replicating data over a network. This may result in a short time window in which the data is not durable (e.g., when the data is inaccessible due to a power failure at a memory device where the data is stored but the data is not yet recovered from the data replication node). In this case, the memory system 100 needs to be blocked from issuing data commit acknowledgement to the host computer system.

In the memory module 110, the DRAM modules 121_1-121_n are coupled with the RAM buffer 122. The RAM buffer 122 can replicate data in a data transaction that is committed to the corresponding memory device 110. The present memory system 100 can provide data replication in a remote memory device and improve data durability without sacrificing the system performance.

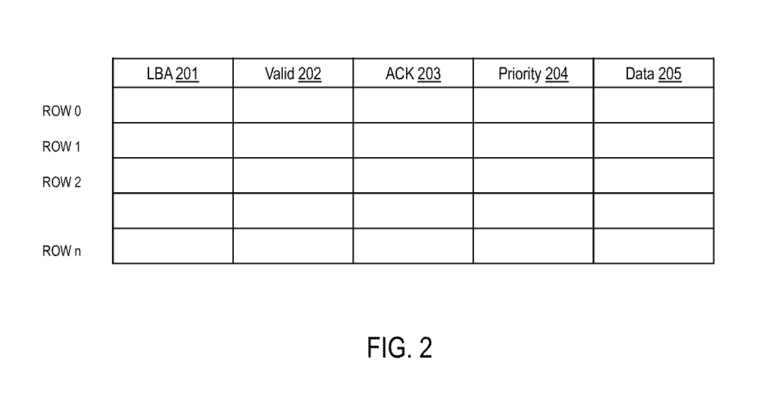

FIG. 2 shows an example data structure of a RAM buffer, according to one embodiment. Data are stored in the RAM buffer in a tabular format. Each row of the data table includes a logical block address (LBA) 201, a valid bit 202, an acknowledgement bit 203, a priority bit 204, and data 205. Data 205 associated with workloads received from the host computer are stored in the RAM buffer along with the LBA 201, the valid bit 202, the acknowledgement bit 203, and the priority bit 204. The priority bit 204 may be optional.

The LBA 201 represents the logical block address of the data. The valid bit 202 indicates that the data is valid. By default, the valid bit of a new data is set. After the data is successfully replicated to a remote node, the valid bit of the data is unset by the remote node.

The acknowledgement bit 203 is unset by default, and is set by a remote node to indicate that the data has been successfully replicated onto the remote node. The priority bit 204 indicates the priority of the corresponding data. Certain data can have a higher priority than other data having a lower priority. In some embodiments, data including critical data are replicated to a remote node with a high priority. Data entries (rows) in the table of FIG. 2 may be initially stored on a first-in and first-out (FIFO) basis. Those data entries can be reordered based on the priority bit 204 to place data of higher priority higher in the table and replicate them earlier than other data of lower priority. The data 205 contains the actual data of the data entry.

According to one embodiment, the RAM buffer is a FIFO buffer. The data entries may be reordered based on the priority bit 204. Some of the data entries stored in the RAM buffer can remain in the RAM buffer temporarily until the data is replicated to a remote node and acknowledged by the remote node to make a space for new data entries. The data entries that have been successfully replicated to the remote node can have the valid bit 202 unset and the acknowledgement bit 203 set. Based on the values of the valid bit 202 and the acknowledgement bit 203, and further on the priority bit 204 (frequently requested data may have the priority bit set accordingly), the memory controller 112 can determine to keep or flush the data entries in the RAM buffer.

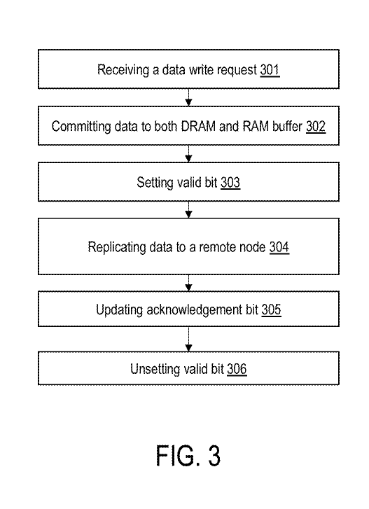

FIG. 3 shows an example data flow for a write request, according to one embodiment. Referring to FIG. 1, a memory driver (not shown) of a host computer (not shown) can commit a data write command to one of the coupled memory devices, for example, the memory device 110a (step 301). The memory device 110a can initially commit the data to one or more of the DRAMs 121a_1-121a_n and the RAM buffer 122a (step 302). The data write command can include an LBA 201 and data 205 to write to the LBA 201. The data write command can further include a priority bit 204 that determines the priority for data replication. In one embodiment, the initial data commit to a DRAM 121 and the RAM buffer 122 can be mapped in a storage address space configured for the memory device 110a.

When committing the data to the RAM buffer 122a, the memory device 110a can set the valid bit 202 of the corresponding data entry in the RAM buffer 122a (step 303). The memory driver of the host computer can commit the data to the memory device 110a in various protocols depending on the system architecture of the host system. For example, the memory driver can send a Transmission Control Protocol/Internet Protocol (TCP/IP) packet including the data write command or issue a remote direct memory access (RDMA) request. In some examples, the RDMA request may be an RDMA over Infiniband protocol, such as the SCSI RDMA Protocol (SRP), the Socket Direct Protocol (SDP) or the native RDMA protocol. In other examples, the RDMA request may be an RDMA over Ethernet protocol, such as the RDMA over Converged Ethernet (ROCE) or the Internet Wide Area RDMA (iWARP) Protocol. It is understood that various data transmission protocols may be used between the memory device 110a and the host computer without deviating from the scope of the present disclosure.

According to one embodiment, the host computer can issue a data replication command to the memory device 110a to replicate data to a specific remote node (e.g., memory device 110b). In response, the memory device 110a can copy the data to the remote node (e.g., memory device 110b) in its RAM buffer (e.g., RAM buffer 122b) over the network.

According to another embodiment, the memory driver of the host computer can commit the data write command to the memory device 110 without knowing that the memory device 110 includes the RAM buffer 122 intended for data replication to a remote node. In this case, the memory device 110a may voluntarily replicate the data to a remote node and send a message to the host computer indicating that replicated data for the committed data is available at the remote node. The mapping information between the memory device and the remote node can be maintained in the host computer such that the host computer can identify the remote node to be able to restore data to recover the memory device from a failure.

The memory device 110a can replicate data to a remote node, in the present example, the memory device 110b (step 304). The optional priority bit 204 of the data entry in the RAM buffer 122a can prioritize data that are more frequently request or critical over less frequently requested data or less critical data in the case of a higher storage traffic. For example, the RAM buffer 122a of the memory device 110a can simultaneously include multiple entries (ROW0-ROWn) for data received from the host computer. The memory device 110a can replicate the data with the highest priority to a remote node over other data with lower priority. In some embodiments, the priority bit 204 can be used to indicate the criticality or frequency of data requested by the host computer.

Based on the communication protocol, the memory device 110a or the remote node 110b that stores replicated data can update the valid bit 202 and the corresponding acknowledgement bit 203 for the data entry in the RAM buffer 122a (step 305). For a TCP/IP based system, the remote node 110b can send an acknowledgement message to the memory device 110a, and the memory device 110a updates the acknowledgement bit 203 and unsets the valid bit 202 for the corresponding data entry (step 306).

In one embodiment, the remote node 110b can directly send an acknowledgement message to the host computer to mark the completion of the requested transaction. In this case, the host computer can send a command to the memory device 110 to unset the acknowledge bit 203 in the RAM buffer 122a for the corresponding data entry. For an RDMA based system, the memory driver of the host system can poll the status of queue completion and update the valid bit 202 of the RAM buffer 122 correspondingly. In this case, the acknowledgement bit 203 of the corresponding data may not be updated.

According to one embodiment, a data write command from the host computer can be addressed to an entry of an existing LBA, i.e., rewrite data stored in the LBA. In this case, the memory device 110a can update the existing data entry in both the DRAM and the RAM buffer 122a, set the valid bit 202, and subsequently update the corresponding data entry in the remote node 110b. The remote node 110b can send an acknowledgement message to the memory device 110a (or the host computer), and the valid bit 202 of the corresponding data entry in the RAM buffer 122a can be unset in similar manner to a new data write.

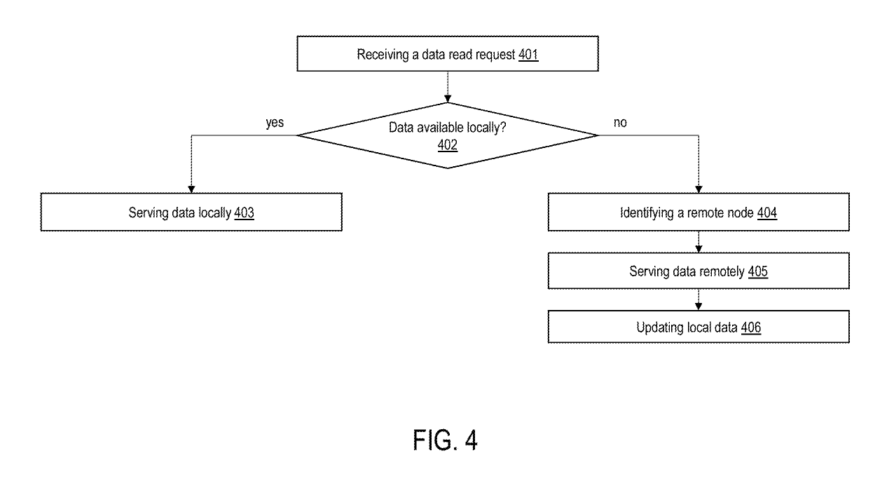

FIG. 4 shows an example data flow for a data read request, according to one embodiment. The memory device 110a receives a data request from a host computer (step 401) and determines to serve the requested data locally or remotely (step 402). If the data is available locally, which is typically the case, the memory device 110a can serve the requested data from either the local DRAM or the local RAM buffer 122a (step 403). If the data is not available locally, for example, due to a power failure, the host computer can identify the remote node 110b that stores the requested data (step 404). In some embodiments, the memory device 110a may have recovered from the power failure, but the data may be lost or corrupted. In that case, the memory device 110a can identify the remote node 110b that stores the requested data. The remote node 110b can directly serve the requested data to the host computer (step 405). After serving the requested data, the remote node 110b sends the requested data to the memory device 110a (when it recovers from the power failure event), and the memory device 110a updates the corresponding data in the DRAM and the RAM buffer 122a accordingly (step 406).

In one embodiment, the memory device 110a stores a local copy of the mapping table stored and maintained in the host computer. If the requested data is unavailable locally in its DRAM or RAM buffer 122a, the memory device 110a identifies the remote node 110b for serving the requested data by referring to the local copy of the mapping table. The host computer and the memory device 110a mutually update the mapping table when there is an update in the mapping information.

In another embodiment, the memory device 110a determines that the requested data is unavailable locally in its DRAM or RAM buffer 122a, the memory device 110a can request the mapping information to the host computer. In response, the host computer can send a message indicating the identity of the remote node 110b back to the memory device 110a. Using the mapping information received from the host computer, the memory device 110a can identify the remote node 110b for serving the requested data. This is useful when the memory device 110a does not store a local copy of the mapping table or the local copy of the mapping table stored in the memory device 110a is lost or corrupted.

In yet another embodiment, the memory device 110a can send an acknowledgement message to the host computer indicating that the requested data is not available locally. In response, the host computer can directly send the data request to the remote node 110b based on the mapping information.

In some embodiments, the memory device 110a can process a data read request to multiple data blocks. For example, the data read request from the host computer can include a data entry with a pending acknowledgement from the remote node 110b. This indicates that the data has not yet been replicated on the remote node 110b. In this case, the memory device 110a can serve the requested data locally as long as the requested data is locally available, and the remote node 110b can update the acknowledgement bit 203 for the corresponding data entry after the memory device 110 serves the requested data. If the local data is unavailable or corrupted, the remote node 110b can serve the data to the host computer (directly or via the memory device 110a), and the memory device 110a can synchronize the corresponding data entry in the RAM buffer 122a with the data received from the remote node 110b.

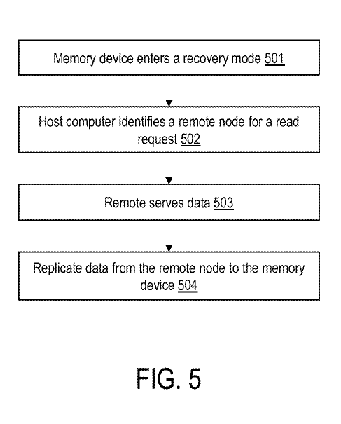

FIG. 5 shows an example data flow for data recovery, according to one embodiment. In the event of a power failure, the memory device 110a enters a recovery mode (step 501). In this case, the local data stored in the DRAM of the memory device 110a can be lost or corrupted. While the memory device 110a recovers from the power failure, the host computer identifies the remote node 110b that stores the duplicate data and can serve the requested data (step 502). The remote node 110b serves the requested data to the host computer (step 503) directly or via the memory device 110a. Upon recovery, the memory device 110a can replicate data from the remote node 110b including the requested data, and cache the replicated data in the local DRAM on a per-block demand basis to aid fast data recovery (step 504). If the data replication acknowledgement from the remote node 110b is pending, the data entry is marked incomplete and the valid bit 202 remains as set in the RAM buffer 122a. In this case, the data in the RAM buffer 122a is flushed either to a system storage or to a low-capacity flash memory on the memory device 110. Upon recovery, the memory device 110a restores the data in a similar manner to a normal recovery scenario.

According to one embodiment, the size of the RAM buffer 122 of the memory device 110 can be determined based on the expected amount of data transactions for the memory device. Sizing the RAM buffer 122 can be critical for meeting the system performance without incurring unnecessary cost. A small-sized RAM buffer 122 could limit the number of outstanding entries to hold data, while a large-sized RAM buffer 122 can increase the cost, for example, due to a larger battery or capacitor for the RAM buffer. According to another embodiment, the size of the RAM buffer is determined based on the dependency on a network latency. For example, for a system having a network round trip time of 50 us for TCP/IP and performance guarantee to commit a page every 500 ns, the RAM buffer 122 can be sized to hold 100 entries with 4 KB data. The total size of the RAM buffer 122 can be less than 1 MB. For an RDMA-based system, the network latency can be less than 10 us because the memory device 110 is on a high-speed network fabric. In this case, a small-sized RAM buffer 122 could be used.

The architecture of the present memory system and the size of the RAM buffer included in a memory device can be further optimized taking into consideration the various conditions and requirements of the system, for example, but not limited to, specific use case scenarios, a read-write ratio, the number of memory devices, latency criticality, data importance, and a degree of replication.

According to one embodiment, a memory device includes: a plurality of volatile memories for storing data; a non-volatile memory buffer configured to store data associated with workloads received from a host computer; and a memory controller configured to store the data to both the plurality of volatile memories and the non-volatile memory buffer and replicate the data to a remote node. The non-volatile memory buffer is configured to store the data in a table including an acknowledgement bit that is set by the remote node.

The non-volatile memory buffer may be DRAM powered by a battery or backed by a capacitor during a power failure event.

The non-volatile memory buffer may be one or more of a phase-change RAM (PCM), a resistive RAM (ReRAM), and a magnetic random access memory (MRAM).

The memory device and the remote node may be connected to each other over a Transmission Control Protocol/Internet Protocol (TCP/IP) network, and the remote node may send the acknowledgement bit to the memory device in a TCP/IP packet.

The memory device and the remote node may communicate with each other via remote direct memory access (RDMA), and the host computer may poll a data replication status of the remote node and update the acknowledgement bit associated with the data in the non-volatile memory buffer of the memory device.

The memory device and the remote node communicate with each other via an RDMA over Infiniband protocol including a SCSI RDMA Protocol (SRP), a Socket Direct Protocol (SDP), and a native RDMA protocol.

The memory device and the remote node communicate with each other via an RDMA over Ethernet protocol including an RDMA over Converged Ethernet (ROCE) and an Internet Wide Area RDMA (iWARP) protocol.

The table may include a plurality of data entries, and each data entry includes a logical block address (LBA), a valid bit, the acknowledgement bit, a priority bit, and the data.

The mapping information of the memory device and the remote node is stored in the host computer.

The non-volatile memory buffer may store frequently requested data by the host computer, and the memory controller may flush less-frequently requested data from the non-volatile memory buffer.

According to another embodiment, a memory system includes: a host computer; a plurality of memory devices coupled to each other over a network. Each of the plurality of memory devices includes: a plurality of volatile memories for storing data; a non-volatile memory buffer configured to store data associated with workloads received from the host computer; and a memory controller configured to store the data to both the plurality of volatile memories and the non-volatile memory buffer and replicate the data to a remote node. The non-volatile memory buffer is configured to store the data in a table including an acknowledgement bit that is set by the remote node.

The non-volatile memory buffer may be either battery-powered or a capacitor-backed during a power failure event.

The non-volatile memory buffer may be one or more of a phase-change RAM (PCM), a resistive RAM (ReRAM), and a magnetic random access memory (MRAM).

The table may include a plurality of data entries, and each data entry includes a logical block address (LBA), a valid bit, the acknowledgement bit, a priority bit, and the data.

According to yet another embodiment, a method for replicating data includes: receiving a data write request including data and a logical block address (LBA) from a host computer; writing the data to one of a plurality of volatile memories of a memory device based on the LBA; creating a data entry for the data write request in a non-volatile memory buffer of the memory device. The data entry includes the LBA, a valid bit, an acknowledgement bit, and the data. The method may further include: setting the valid bit of the data entry; replicating the data to a remote node; receiving an acknowledgement that indicates a successful data replication to the remote node; updating the acknowledgement bit of the data entry based on the acknowledgement; and updating the valid bit of the data entry.

The method may further include: receiving a data read request for the data from the host computer; determining that the data is locally available from the memory device; and sending the data stored in the memory device to the host computer.

The data stored in the non-volatile memory buffer may be sent to the host computer.

The method may further include: receiving a data read request for the data from the host computer; determining that the data is not locally available from the memory device; identifying the remote node that stores the replicated data; sending the data stored in the remote node to the host computer; and updating the data stored in one of the volatile memories and the non-volatile memory buffer of the memory device.

The method may further include: determining that the memory device has entered a recover mode from a failure; identifying the remote node for a read request for the data; sending the data from the remote node; and replicate the data from the remote node to the memory device.

The method may further include receiving the acknowledgement bit in a TCP/IP packet from the remote node.

The memory device and the remote node may communicate with each other via remote direct memory access (RDMA), and the method may further include polling a data replication status of the remote node and updating the acknowledgement bit of the data associated with the data in the non-volatile memory buffer of the memory device.

The memory device and the remote node communicate with each other via an RDMA over Infiniband protocol including a SCSI RDMA Protocol (SRP), a Socket Direct Protocol (SDP), and a native RDMA protocol.

The memory device and the remote node communicate with each other via an RDMA over Ethernet protocol including an RDMA over Converged Ethernet (ROCE) and an Internet Wide Area RDMA (iWARP) protocol.

The non-volatile memory buffer may be battery-powered or a capacitor-backed or selected from a group comprising a phase-change RAM (PCM), a resistive RAM (ReRAM), and a magnetic random access memory (MRAM).

The above example embodiments have been described hereinabove to illustrate various embodiments of implementing a system and method for providing a DRAM appliance for data persistence. Various modifications and departures from the disclosed example embodiments will occur to those having ordinary skill in the art. The subject matter that is intended to be within the scope of the invention is set forth in the following claims.

What is claimed is:

1. A memory device comprising:
a plurality of volatile memories for storing data;
a non-volatile memory buffer configured to store data associated with workloads received from a host computer; and
a memory controller configured to store the data to both the plurality of volatile memories and the non-volatile memory buffer and replicate the data to a remote node,
wherein the non-volatile memory buffer is configured to store the data in a table including an acknowledgement bit that is set by the remote node.

2. The memory device of claim 1, wherein the non-volatile memory buffer is DRAM powered by a battery or backed by a capacitor during a power failure event.

3. The memory device of claim 1, wherein the non-volatile memory buffer is one of a phase-change RAM (PCM), a resistive RAM (ReRAM), and a magnetic random access memory (MRAM).

4. The memory device of claim 1, wherein the memory device and the remote node are connected to each other over a Transmission Control Protocol/Internet Protocol (TCP/IP) network, and wherein the remote node sends the acknowledgement bit to the memory device in a TCP/IP packet.

5. The memory device of claim 1, wherein the memory device and the remote node communicate with each other via remote direct memory access (RDMA), and wherein the host computer polls a data replication status of the remote node and updates the acknowledgement bit associated with the data in the non-volatile memory buffer of the memory device.

6. The memory device of claim 1, wherein the memory device and the remote node communicate with each other via an RDMA over Infiniband protocol including a SCSI RDMA Protocol (SRP), a Socket Direct Protocol (SDP), and a native RDMA protocol.

7. The memory device of claim 1, wherein the memory device and the remote node communicate with each other via an RDMA over Ethernet protocol including an RDMA over Converged Ethernet (ROCE) and an Internet Wide Area RDMA (iWARP) protocol.

8. The memory device of claim 1, wherein the table includes a plurality of data entries, and each data entry includes a logical block address (LBA), a valid bit, the acknowledgement bit, a priority bit, and the data.

9. The memory device of claim 1, wherein the mapping information of the memory device and the remote node is stored in the host computer.

10. The memory device of claim 1, wherein the non-volatile memory buffer stores frequently requested data by the host computer, and wherein the memory controller flushes less-frequently requested data from the non-volatile memory buffer.

11. A memory system comprising:
a host computer;
a plurality of memory devices coupled to each other over a network,
wherein each of the plurality of memory devices comprises:
a plurality of volatile memories for storing data;
a non-volatile memory buffer configured to store data associated with workloads received from the host computer; and
a memory controller configured to store the data to both the plurality of volatile memories and the non-volatile memory buffer and replicate the data to a remote node,
wherein the non-volatile memory buffer is configured to store the data in a table including an acknowledgement bit that is set by the remote node.

12. The memory system of claim 11, wherein the non-volatile memory buffer is DRAM powered by a battery or backed by a capacitor during a power failure event.

13. The memory system of claim 11, wherein the non-volatile memory buffer is one or more of a phase-change RAM (PCM), a resistive RAM (ReRAM), and a magnetic random access memory (MRAM).

14. The memory system of claim 11, wherein the table includes a plurality of data entries, and each data entry includes a logical block address (LBA), a valid bit, the acknowledgement bit, a priority bit, and the data.

15. A method comprising:
receiving a data write request including data and a logical block address (LBA) from a host computer;
writing the data to one of a plurality of volatile memories of a memory device based on the LBA;
creating a data entry for the data write request in a non-volatile memory buffer of the memory device, wherein the data entry includes the LBA, a valid bit, an acknowledgement bit, and the data;
setting the valid bit of the data entry;
replicating the data to a remote node;
receiving an acknowledgement that indicates a successful data replication to the remote node;
updating the acknowledgement bit of the data entry based on the acknowledgement; and
updating the valid bit of the data entry.

16. The method of claim 15, further comprising:
receiving a data read request for the data from the host computer;
determining that the data is locally available from the memory device; and
sending the data stored in the memory device to the host computer.

17. The method of claim 16, wherein the data stored in the non-volatile memory buffer is sent to the host computer.

18. The method of claim 15, further comprising:
receiving a data read request for the data from the host computer;
determining that the data is not locally available from the memory device;
identifying the remote node that stores the replicated data;
sending the data stored in the remote node to the host computer; and
updating the data stored in one of the volatile memories and the non-volatile memory buffer of the memory device.

19. The method of claim 15, further comprising:
determining that the memory device has entered a recover mode from a failure;
identifying the remote node for a read request for the data;
sending the data from the remote node; and
replicate the data from the remote node to the memory device.

20. The method of claim 15, further comprising receiving the acknowledgement bit in a TCP/IP packet from the remote node.

21. The method of claim 15, wherein the memory device and the remote node communicate with each other via remote direct memory access (RDMA), and the method further comprising polling a data replication status of the remote node and updating the acknowledgement bit of the data associated with the data in the non-volatile memory buffer of the memory device.

22. The method of claim 15, wherein the memory device and the remote node communicate with each other via an RDMA over Infiniband protocol including a SCSI RDMA Protocol (SRP), a Socket Direct Protocol (SDP), and a native RDMA protocol.

23. The method of claim 15, wherein the memory device and the remote node communicate with each other via an RDMA over Ethernet protocol including an RDMA over Converged Ethernet (ROCE) and an Internet Wide Area RDMA (iWARP) protocol.

24. The method of claim 15, wherein the non-volatile memory buffer is battery-powered or a capacitor-backed or selected from a group comprising a phase-change RAM (PCM), a resistive RAM (ReRAM), and a magnetic random access memory (MRAM).
